(19) United States
(12) Patent Application Publication
(10) Pub. No.: US 2007/0114445 A1
(43) Pub. Date: May 24, 2007

(54) Canister-type dosimeter and multidimensional mapping of absolute radiation dosage distribution using said dosimeter

(76) Inventors: Thomas Ellwood Schell, Midland Park, NJ (US); David F. Lewis, Monroe, CT (US)

Correspondence Address: WILLIAM J. DAVIS;INTERNATIONAL SPECIALTY PRODUCTS, BLDG.8-2, 1361 ALPS ROAD, WAYNE, NJ, 07470, US

(21) Appl. No.: 11/602,554

(22) Filed: Nov. 21, 2006

Related U.S. Application Data
(60) Provisional application No. 60/738,948, filed on Nov. 22, 2005.

(51) Int. Cl. G01T 1/08

(52) U.S. Cl. 250/474.1

(57) ABSTRACT

The invention pertains to a dosimeter using a canister-type irradiator having a void area adapted to contain material to be processed by irradiation and absolute dose distribution indicia which indicia comprises (i) a radiochromic, self-developing, radiation sensitive film enclosed in a radiation transmitting leak proof housing and fixedly mounted in the canister and (ii) an absolute dosage measuring amount of alanine fixedly mounted in a leak proof receptacle on the outer surface of the housing at a location overlaying said film. The invention also relates to an improved canister-type irradiator apparatus and its method of operation.

This application claims priority of U.S. Ser. No. 60/738,948, filed Nov. 22, 2005, the disclosure of which is hereby incorporated herein in its entirety

### FIELD OF THE INVENTION

The invention is directed to more precise dosage distribution measurements absorbed by a radiation treatable material and to an improved canister type irradiator apparatus as well as to the process for determining absolute dosage distribution measurements collected by co-acting dosage indicia which correspond to the dosage distribution absorbed by the radiation treatable material. The invention also concerns more accurate multidimensional mapping of relative dosage distribution measurements collected by a radiochromic film of the present dosage indicia.

### BACKGROUND OF THE INVENTION

Dosimeters having canister type irradiators containing a radiation sensitive film are known and described in U.S. patent literature e.g. as illustrated in U.S. Pat. No. 5,359,200. The film in the prior devices measures relative dosages of radiation in a given wavelength and the measurements applied to dosages suitable for certain radiation alterable material, referred to as the “target material”. In radiation therapy where the target material is a living organism or bodily fluid, it is crucial to accurately determine the precise range of absorbed radiation so as to avoid over exposure causing damage to the target or body organs and tissues or under exposure which is insufficient to destroy unwanted components or contaminating elements of the target. Accordingly, more precise and accurate means of determining dosage distribution data within the dosimeter for absorption of the target material is of prime importance.

In general practice, it has been found that, while radiation sensitive films are capable of measuring the relative dosage distribution within the dosimeter, the measurements are subject to significant deviations resulting from varied environmental or climatic conditions which arise between the site of calibration and the actual radiation therapy or may occur in the lapse of time between initial verification of the film and its actual use in the dosimeter. Hence means capable of providing a precise and absolute dosage distribution measurement to correct deviations in the overall relative dosage measurements collected by the film is needed to avoid radiation over-or under-exposures of the target material and to provide an accurate multidimensional mapping profile based on absolute dosage measurements absorbed within the canister. Accordingly, it is an object of the present invention to provide an improved dosimeter having such deviation correction capability.

Another object of the invention is to provide an inexpensive and commercially feasible method for accurate and precise measurement of radiation dosage distribution for a multidimensional mapping display.

Another object is to provide an improved dosimeter apparatus for measuring radiation dosage distribution absorbed by a selected target material.

Still another object is to provide improved radiation dosage indicia within an irradiator apparatus.

These and other objects and advantages of this invention will become apparent from the following disclosure.

### DEFINITION OF TERMS

For clarification, the terms used in this disclosure are defined below.
The Improved Dosimeter comprises essentially an ionizing radiation treating canister having (a) void area adapted to contain material to be irradiated and (b) radiation dose distribution indicia fixedly mounted therein in leak proof mode.
Radiation dose distribution indicia comprises a film, suitable for measuring the relative dosage distribution within the canister, which is positioned in abutment with the inner surface of a leak proof, radiation transmitting housing and a leak proof receptacle containing absolute dosage measuring amount of alanine mounted on the outer surface of the housing at a site overlaying the film.
Alanine is a crystalline amino acid capable of forming free radicals upon irradiation and is employed at a sufficient mass density and in a quantity required to provide measurement of the absolute radiation dosage at at least one site overlaying at least one location of the film.
The target material is an ionizing irradiatable substance and includes organic and inorganic liquids and solids such as for example food products, body fluids, e.g. blood, serums, medicaments and components thereof, insect pupae, a body replacement part or organ, a surgical dressing or article and the like. Water can be included as a phantom target.

### SUMMARY OF THE INVENTION

In accordance with this invention there is provided an interacting dosage distribution recording medium consisting essentially of (i) a self developing, radiochromic polymerizable polyacetylenic film suitable for providing measurements of the relative dosage distribution administered to a target radiation treatable material (TIM) and (ii) a separate, co-acting, relative-dosage-correcting amount of an absolute dosage measuring mass of alanine, which components (i) and (ii) function as indicia for measurement of the absolute dosage distribution administered to a selected TIM within a canister type irradiator having (a) a void area adapted to contain TIM and (b) the dosage measuring indicia assembly fixedly mounted in leak proof containers within the canister. Generally, the film is enclosed in a fixedly mounted radiation transmitting, leak proof housing the outer surface of which is attached to at least one leak proof receptacle overlaying at least one location of the film, each receptacle containing an absolute dosage measuring mass of alanine. The present dosimeter is adapted to administer and indicate the precise dosage absorbed by a TIM and to provide data for a multidimensional display of irradiation volume generated in the canister in an accuracy heretofore unobtainable.

### DETAILED DESCRIPTION OF THE INVENTION

As indicated above, the improvement in the present dosimeter resides in the ability to correct variations in the relative radiation dosage distribution measurements based on radiation absorption of the radiochromic film (RID) and to convert these measurements to absolute radiation dosage distributions (AID) measured by the alanine component to provide more accurate mapping of dosage distribution within the canister and effectively absorbed by the TIM. This is accomplished by independent dosage measurements of RID and AID on at least one location over the film and indexing the RID measurements to AID measurement or measurements by applying a correction factor expressed by the formula

$$CF = Correction Factor = \frac{Alanine Dose}{RID}$$

$$AID - CF RID$$

In the present invention, the alanine component is preferably in the form of a pellet or pill contained in a leak proof receptacle which overlays a location of the RID film, most preferably at least the central location of the RID film. Generally the RID film is removably contained in a leak proof housing or cassette fixedly mounted in the canister together with one or more leak proof receptacles containing alanine affixed to the outer wall of the housing at a location over the enclosed film. As indicated, a plurality of alanine containing receptacles can be affixed at various locations over the film on one or both outer surfaces of the housing. However, the improvement in dosage distribution measurement is achieved by the use of one centrally located alanine-containing receptacle. When multiple alanine sites are employed, the absolute radiation dosage for each site is determined and, with sufficient absolute dosage measurement sites, the above formula for correction of the overall relative dosage distribution collected by the film with one centrally located alanine site can be omitted; however, individual determinations of absolute dosage and correction of relative dosage at multiple sites significantly increases the cost of the dosimeter operation and is not preferred.

The radiochromic film employed in the present dosimeter is a conjugated preferably C₈-C₂₈ polymerizable polyacetylenic compound which includes polyacetylenic acids and metal salts, particularly lithium salts, thereof. Films of 10,12-penta-cosapolyacetylene, 10,12-pentacosadiynoic acid and their lithium salts are most preferred. GAFCHROMIC® film, available from International Specialty Products is an example of the particularly preferred radiochromic component. The radiochromic film employed provides a visual response by change of color, the intensity of which corresponds to the amount of radiation absorbed which can be measured by a scanner, optical or spectrophotometer. The unexposed radiochromic film is composed of sub-micron sized crystals which, upon ionizing radiation, undergo a polymerization visually expressed by color development, the intensity of which indicates the amount of radiation absorbed. The optical density measurements are converted to radiation dose (cGy) based on a previous calibration of the radiochromic film at an accredited laboratory. These measurements are used to provide the relative dosage distribution within the dosimeter.

The shape of the film conforms with that of its housing which may be square, circular or rectangular and is removably mounted therein for subsequent recovery and measurement of absorbed radiation by color intensity development.

Suitable radiation employed herein are ionizing radiations generated from high or low energy sources including γ-rays, x-rays, α-particles, electron, neutron, proton and ion beam emanations which encompass a wide range of energies as low as about 5 KeV up to about 100 MeV. It will be appreciated that with the diversity of TIM radiatable by the present invention, suitable energy sources will be selected. For example, when blood or another body fluids or serums is selected for TIM radiation therapy, γ-ray or x-ray energy sources are preferably selected for radiation. Effective radiation of the TIM can be achieved within a few seconds up to abut 10 minutes, more usually within 4-6 minutes. In the case of blood radiation therapy, it is found that effective radiation with x-rays for 5-6 minutes provide the desired dosage exposure.

In order to test the proper radiation dosage for a particular TIM, water as a substitute or phantom TIM in the void area of the canister to simulate proper TIM radiation dosages, radiation dosage range distribution, energy source and duration of exposure within the dosimeter. However, it is to be understood that other inexpensive radiatable materials, e.g. PlasticWater™ can be selected as the phantom TIM to perform these functions.

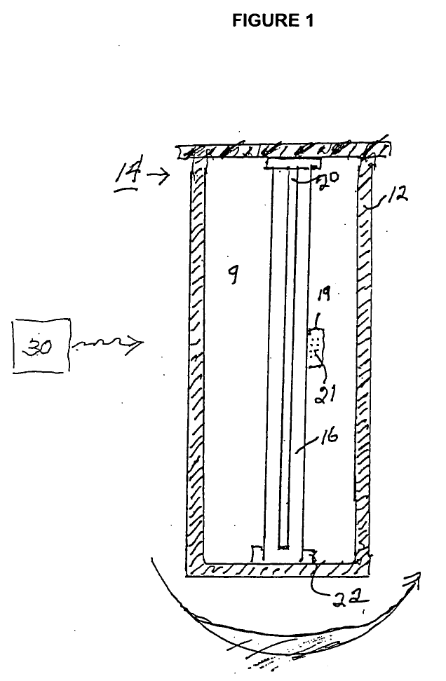

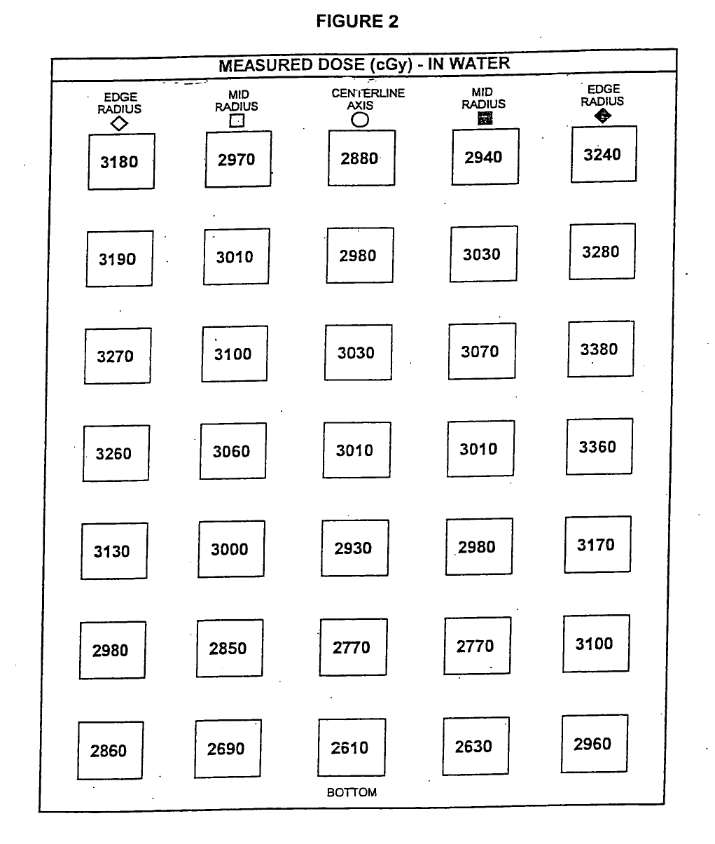

In the process of the present invention, the canister is preferably of the rotating type illustrated and described in U.S. Pat. No. 5,359,200 with the exception that an alanine containing receptacle is added to the outer surface of the cassette as shown in FIG. 1 corresponding to FIG. 2 of the patent. The entire description and disclosure of said patent is incorporated herein by reference. In this embodiment the alanine containing receptacle is attached to the outer wall of the cassette panel by adhesive or by embedding it in the panel surface in a leak proof mode. It is also within the scope of this invention to employ alternative dosimeters where the canister is stationary and at least one source of radiation energy is rotated around the canister. Another alternative involves a stationary canister where stationary top and bottom, similar or dissimilar sources of energy are employed to radiate the content of the canister. Other dosimeter arrangements are also applicable in this invention provided that they include the radiation dosage measuring indicia described herein.

The size of the cassette or housing is that which substantially fills a vertical or horizontal cross sectional area of the canister and, as indicated above, its shape can be circular, square or rectangular.

In the accompanying figures, FIG. 1 is a cross sectional view of a dosimeter having a rotating canister generally corresponding to FIG. 2 of U.S. Pat. No. 5,359,200. FIG. 2 illustrates absorbed dose (cGy) indexed to specific degrees. of radiation absorbed by the film.

### DETAILED DESCRIPTION OF THE DRAWINGS

In FIG. 1, dosimeter 14 comprises rotatable canister 12 having void area 9 adapted to contain the TIM and fixedly mounted leak proof cassette 16 which encloses radiochromic film 20 removably inserted therein. On the outer central portion of cassette 16 there is fixedly mounted leak proof receptacle 19 which contains an absolute radiation dosage measuring amount of alanine pellet 21, indicated by broken line. The cassette is held in place by a clip on top and/or by optional anchoring means represented by 22. The stationary source of radiation is indicated by numeral 30.

FIG. 2 represents an example of a Dose-MAP® report showing absorbed dose in areas of the film. The optical density measurements are converted to radiation dose units based on a previous independent calibration of the film preferably at an accredited laboratory traceable to NIST.

Having generally described the invention, reference is had to the following example which illustrates a preferred embodiment but which is not to be construed as limiting to the scope of the invention as more broadly defined in the appended claims.

### EXAMPLE 1

In this example, water is employed to simulate blood in effective blood radiation therapy with reference to FIG. 1 of the drawings. In an irradiator canister (12), water is introduced into void area 9 and 3×5 inch GAFCHROMIC® film (10,12-pentacosadiynoic acid) 20 is removably positioned in leak proof cassette 16. Plastic receptacle 19 containing a 66.5 gram alanine pellet 21 is attached to outer mid-surface area of cassette 16 in indirect engagement with film 20.

Canister 12 is rotated past energy source 30 using γ-rays (Gammacell 1000 Elite Serial 323) and receives a target dose of 2700 cGy for a duration of 3 minutes and 18 seconds, during which alanine pellet 21 and film 20 are simultaneously irradiated. Over the area of film 20 the relative degrees of radiation absorbed by film 20 recorded by variations in blue color intensities, thereby indicating the radiation dosage distribution in canister 12. Film 20 is then removed from cassette 16 and the color development in each area, representing the relative radiation dosage distribution, is translated using a predetermined calibration curve into absorbed dose units as shown in FIG. 2, whereby the total relative radiation dosage distribution within the canister is indicated.

Receptacle 19 containing alanine pellet 21 is separated from cassette 16 and sent to an accredited laboratory or NIST for a numerical read out of the absolute radiation dosage absorbed at the site where the pellet inside of receptacle 19 overlays film 20 contained inside of cassette 16. The relative absorbed doses of the film are indexed to correspond to the absolute radiation dosage distribution measurement by extrapolating the absolute value at a given site with all relative dosage values at other sites and the resulting, corrected radiation dosage distribution values are employed to provide a visual three dimensional display.

### EXAMPLE 2

Example 1 is repeated except that human blood bags are substituted for water in area 9 of canister 12 and the blood is effectively irradiated against contamination within the accurate parameters described.

What is claimed is:

1. An improved radiation dosage measuring composition for a dosimeter comprising a self developing, radiochromic film suitable for measuring the relative radiation dosage distribution within the dosimeter and a co-acting, absolute radiation measuring amount of alanine in communication with said film and irradiated simultaneously with said film.

2. The alanine is in the form of a pellet.

3. The improved radiation dosage measuring composition of claim 1 wherein the alanine is in the form of a plurality of alanine pellets which individually measure the absolute radiation dosage at various sites of the film.

4. An improved dosimeter apparatus for a canister type irradiator which comprises:
(i) a void area adapted to contain an ionizing-radiatable target material
(ii) a self developing radiochromic film for measuring the relative radiation dosage distribution within the dosimeter;
(iii) an absolute radiation dosage measuring amount of solid alanine in communication with said film and simultaneously irradiated with said film.

5. The improved dosimeter of claim 4 wherein a plurality of component (iii) are in communication with said film at various sites and wherein each of the (iii) components individually measures the absolute radiation dosage at its respective film communicating site.

6. The improved dosimeter of claim 4 wherein said alanine is in the form of a pellet and is enclosed in a water proof receptacle positioned above said film.

7. The improved dosimeter of claim 6 wherein said film is enclosed in a water proof housing fixedly mounted in the dosimeter and the alanine pellet communicates with said film through said housing.

8. The improved dosimeter of claim 7 wherein said alanine pellet is contained in a water proof receptacle and the alanine communicates with said film by attachment to said housing at a midsection of the film enclosed therein.

9. A process for more accurately determining the range of radiation dosage received by a radiable target material in a dosimeter which comprises:
(A) introducing said target material into a void area of a canister type dosimeter having
(a) fixedly mounted, water proof housing containing a self developing, radiochromic film adapted to measure the relative radiation dosage distribution within the canister and
(b) an absolute radiation dosage measuring amount of an alanine pellet contained in a water proof receptacle and fixedly positioned on the outer wall of said housing at a site where said pellet overlays the said film contained therein,
(B) supplying ionizable radiation to said canister for simultaneous radiation of the target material, the film and the alanine pellet;
(C) collecting the relative radiation dosage distribution measurements of radiation absorbed by the film;
(D) employing the absolute radiation dosage measured by the alanine pellet to correct any deviation in the relative radiation dosage at the site of pellet/film communication and extrapolating the absolute dosage correction to the remaining measurements of relative radiation dosages and
(E) adjusting the ionizing radiation supplied to the canister in accordance with the corrected radiation dose measurements to coincide with the desired range of radiation prescribed for the treatment of the target material.

10. The process of claim 9 wherein the collated data of (C) and (D) is displayed in a three dimensional graph or map illustrating the radiation dose distribution within the dosimeter in absolute values.

11. The use of an absolute radiation dosage measurement obtained by an aniline pellet in a dosimeter to correlate and correct any deviation in the relative radiation dosage distribution measurements obtained from a self developing radiochromic film.
